(19) United States
(12) Patent Application Publication
(10) Pub. No.: US 2008/0074789 A1
(43) Pub. Date: Mar. 27, 2008

(54) Head slider having protruding head element and apparatus for determining protrusion amount of head element

(75) Inventor: Shinichi Takahashi, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/699,629

(22) Filed: Jan. 30, 2007

(30) Foreign Application Priority Data
Sep. 26, 2006 (JP) 2006-260057

(51) Int. Cl. G11B 5/60

(52) U.S. Cl. 360/234.4

(57) ABSTRACT

A head slider has a medium-opposed surface defining first and second areas extending side by side from the inflow end to the outflow end. A head element is embedded in an insulating non-magnetic film. The head element at least locates a write gap in a first section defined in the insulating non-magnetic film in the first area. A first actuator is embedded in the insulating non-magnetic film in the first area. The first actuator causes the first section to protrude. A second actuator is embedded in the insulating non-magnetic film in the second area. The second actuator causes a second section of the insulating non-magnetic film to protrude. The second section is utilized in a so-called zero calibration. The first section and the head element are prevented from protruding during the zero calibration. This results in are liable avoidance of damage to the head element.

### BACKGROUND OF THE INVENTION

1. Field of the Invention

The present invention relates to ahead slider incorporated in a storage medium drive such as a hard disk drive, HDD.

2. Description of the Prior Art

A head slider including an actuator for driving a head element is well known. An insulating non-magnetic film is overlaid on the outflow end surface of a slider body in the head slider. Ahead element is embedded within the non-magnetic film. A heating wiring pattern is embedded in the head element. The heating wiring pattern generates heat in response to the supply of electric current. The head element is allowed to get closer to a magnetic recording disk with the assistance of expansion of the insulating non-magnetic film.

When the head sliders are incorporated in hard disk drives, the head sliders suffer from dispersion of the flying height in a range between 2 nm and 3 nm approximately. A so-called zero calibration is effected to correct the flying height. The zero calibration forces the actuator to move the head element during the flight of the head slider. The head element is required to gradually get closer to the magnetic recording disk. Contact is detected between the head element and the magnetic recording disk. The protrusion amount of the head element is measured during the contact. The protrusion amount of the head element during the read/write operation is determined based on the detected protrusion amount of the head element.

The head element is brought in contact with the magnetic recording disk for detection of the protrusion amount in the aforementioned zero calibration. The contact often induces damages to the head element and/or abrasion of a protection film covering over the end of the head element, for example. The abrasion of the protection film causes a failure in a sufficient protection of the head element from corrosion. A prior Japanese patent application No. 2006-023168, not yet published, also relates to the present invention.

### SUMMARY OF THE INVENTION

It is accordingly an object of the present invention to provide a head slider and a storage medium drive both capable of determining the protrusion amount of a head element without inducing any damages to the head element. It is also an object of the present invention to provide an apparatus for determining a protrusion amount of a head element without inducing any damages to the head element.

According to a first aspect of the present invention, there is provided a head slider comprising: a slider body having a medium-opposed surface opposed to a storage medium, the medium-opposed surface defining first and second areas extending side by side from the inflow end to the outflow end; an insulating non-magnetic film overlaid on the outflow end surface of the slider body; a head element embedded in the insulating non-magnetic film, the head element at least locating a write gap in a first section defined in the insulating non-magnetic film in the first area; a first actuator embedded in the insulating non-magnetic film in the first area, the first actuator causing the first section of the non-magnetic film to protrude; and a second actuator embedded in the insulating non-magnetic film in the second area, the second actuator causing a second section of the insulating non-magnetic film to protrude.

The head slider allows the second actuator to cause protrusion of the second section of the insulating non-magnetic film. The second section is utilized in a so-called zero calibration. The first section and the head element are prevented from protruding during the zero calibration. This results in a reliable avoidance of damage to the head element. In addition, if the protrusion amount of the second section correctly reflects the protrusion amount of the first section, the protrusion amount of the first section and the head element can be determined based on the protrusion amount of the second section. The flying height of the head element is in this manner correctly determined. The flying height is uniformly set for the head sliders.

The first actuator may include a heating wiring pattern embedded in the first section of the insulating non-magnetic film. The second actuator may likewise include a heating wiring pattern embedded in the second section of the insulating non-magnetic film. These heating wiring patterns are supplied with electric current. The heating wiring patterns generate heat in response to the supply of electric current. This results in expansion of the insulating non-magnetic film at a position adjacent to the heating wiring patterns. The first and second sections are in this manner caused to protrude. If a relationship is figured out between the amount of electric current supplied to the heating wiring patterns and the protrusion amount of the first and second sections, respectively, the protrusion amount of the first and second sections can be adjusted in a facilitated manner.

The head slider may be employed in a specific storage medium drive, for example. The specific storage medium drive may comprise: a storage medium; a head slider having a medium-opposed surface opposed to the storage medium, the medium-opposed surface defining first and second areas extending side by side from the inflow end to the outflow end; an insulating non-magnetic film overlaid on the outflow end surface of the head slider; a head element embedded in the insulating non-magnetic film, the head element at least locating a write gap in a first section defined in the insulating non-magnetic film in the first area; a first actuator embedded in the insulating non-magnetic film in the first area, the first actuator causing the first section of the insulating non-magnetic film to protrude; and a second actuator embedded in the insulating non-magnetic film in the second area, the second actuator causing a second section of the insulating non-magnetic film to protrude.

According to a second aspect of the present invention, there is provided a determination apparatus for determining protrusion amount of a head element, the determination apparatus comprising: a controlling section designed to cause a non-magnetic film of a head slider to protrude without causing a protrusion of a head element embedded in the non-magnetic film; a detection section designed to detect contact between the non-magnetic film and a storage medium in response to increase in a protrusion amount of the non-magnetic film; and a determination section designed to determine the protrusion amount of the head element based on the protrusion amount of the non-magnetic film during the contact.

The non-magnetic film of the head slider is caused to protrude in the zero calibration in the determination apparatus. Contact is detected between the non-magnetic film and the storage medium in response to increase in the protrusion of the non-magnetic film. The head element is in this case prevented from protruding. This results in a reliable avoidance of damage to the head element. Moreover, the protrusion amount of the head element is determined based on the protrusion amount of the non-magnetic film during the contact.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a storage medium drive according to the present invention;

FIG. 2 is a perspective view schematically illustrating a flying head slider;

FIG. 3 is a plan view of the flying head slider observed at a medium-opposed surface;

FIG. 4 is an enlarged front view of an electromagnetic transducer observed at a medium-opposed surface or air bearing surface;

FIG. 5 is a sectional view taken along the line 5-5 in FIG. 4;

FIG. 6 is an enlarged front view of the electromagnetic transducer, corresponding to FIG. 4, schematically illustrating the positions of heating wiring patterns in accordance with a specific embodiment;

FIG. 7 is a view schematically illustrating contact between a second section and a magnetic recording disk;

FIG. 8 is a schematic view showing the waveform observed at an oscilloscope when the second section is distanced from the magnetic recording disk;

FIG. 9 is a schematic view showing the waveform observed at the oscilloscope when the second section is in contact with the magnetic recording disk;

FIG. 10 is an enlarged front view of an electromagnetic transducer, corresponding to FIG. 4, schematically illustrating the positions of heating wiring patterns in accordance with another embodiment; and

FIG. 11 is a schematic view illustrating protrusion of first and second sections.

### DESCRIPTION OF THE PREFERRED EMBODIMENTS

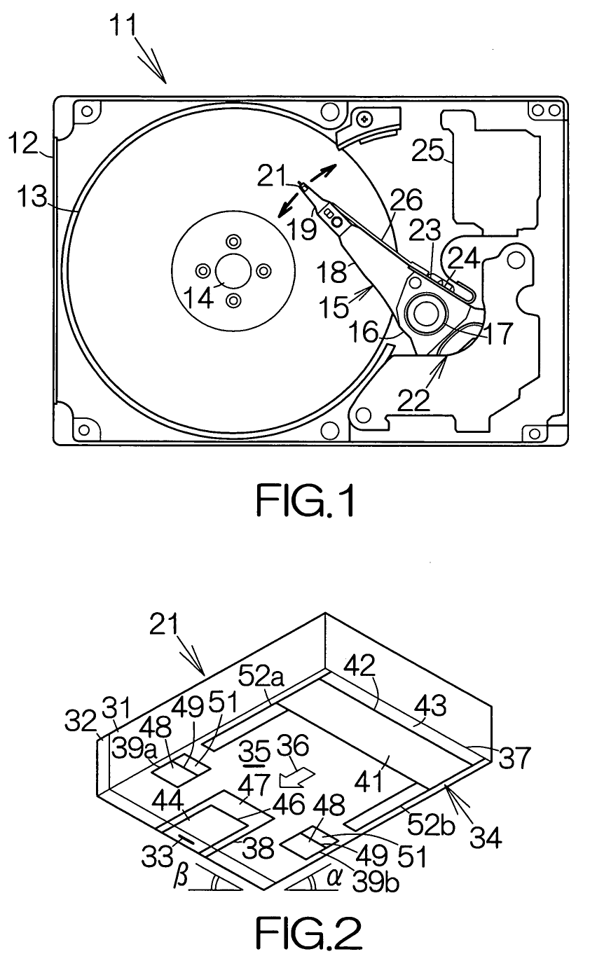

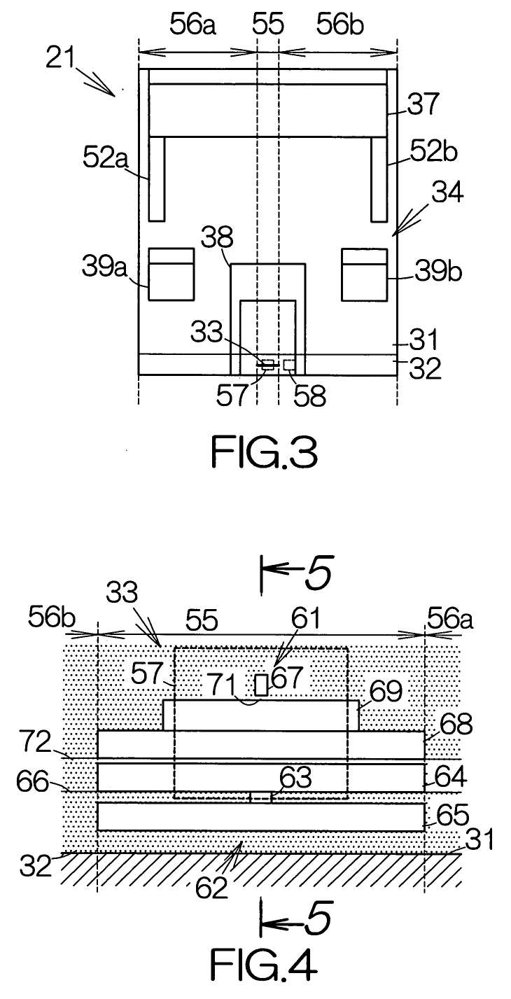

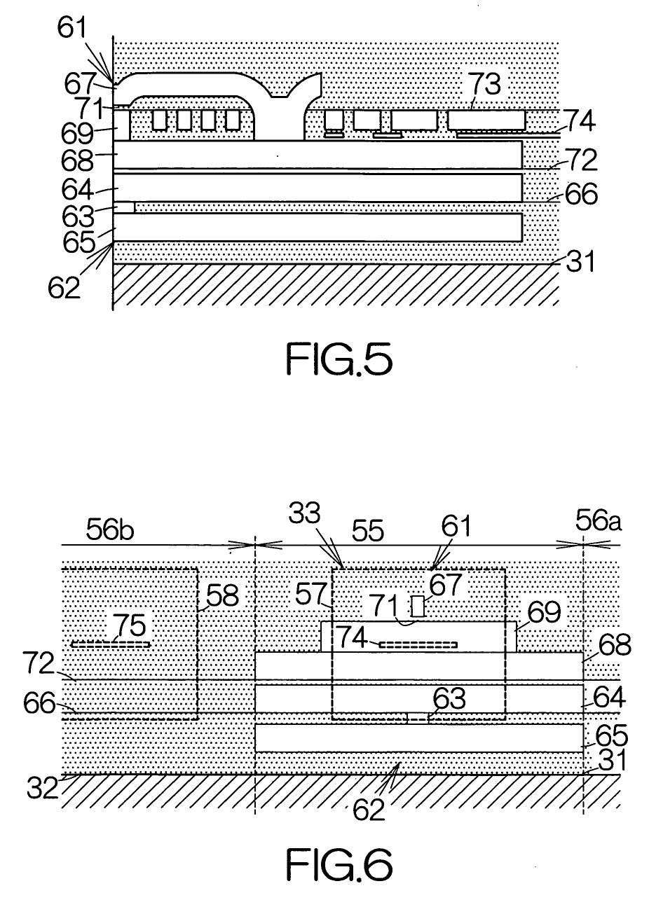

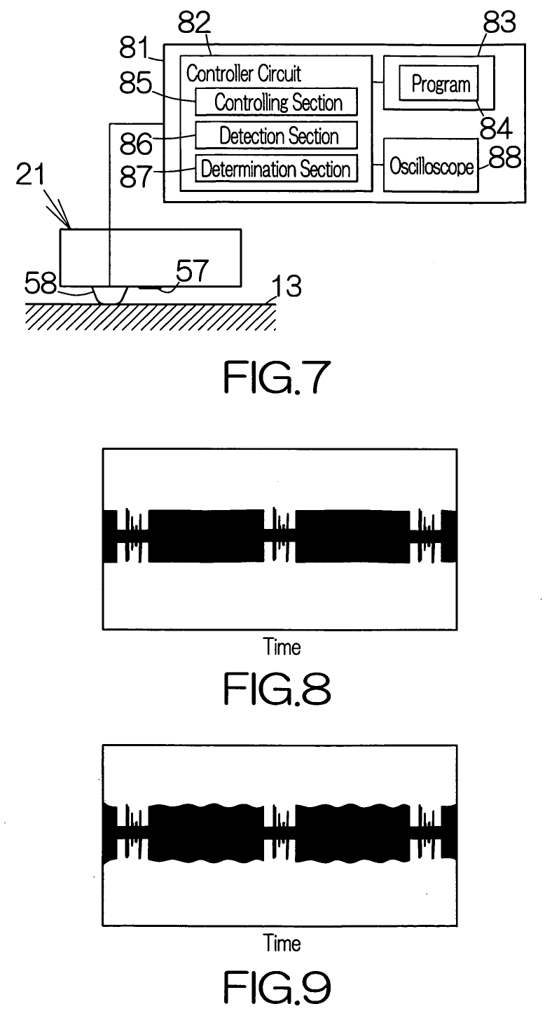

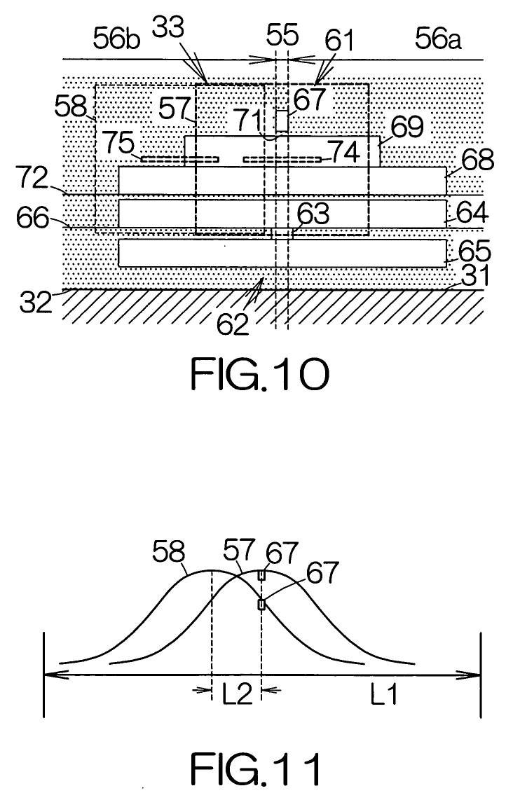

FIG. 1 schematically illustrates the structure of a hard disk drive, HDD, 11 as an example of a storage medium drive or a storage device according to the present invention. The hard disk drive 11 includes a box-shaped enclosure body 12 defining an inner space in the form of a flat parallelepiped, for example. The enclosure body 12 may be made of a metallic material such as aluminum, for example. Molding process may be employed to form the enclosure body 12. An enclosure cover, not shown, is coupled to the enclosure body 12. An inner space is defined between the enclosure body 12 and the enclosure cover. Pressing process may be employed to form the enclosure cover out of a plate material, for example. The enclosure body 12 and the enclosure cover in combination establish an enclosure.

At least one magnetic recording disk 13 as a storage medium is enclosed in the enclosure body 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rpm, or the like.

A carriage 15 is also enclosed in the enclosure body 12. The carriage 15 includes a carriage block 16. The carriage block 16 is supported on a vertical support shaft 17 for relative rotation. Carriage arms 18 are defined in the carriage block 16. The carriage arms 18 are designed to extend in the horizontal direction from the vertical support shaft 17. The carriage block 16 may be made of aluminum, for example. Extrusion molding process maybe employed to form the carriage block 16, for example.

A head suspension 19 is fixed to the tip end of the individual carriage arm 18. The head suspension 19 is designed to extend forward from the tip end of the carriage arm 18. A gimbal spring, not shown, is connected to the tip end of the individual head suspension 19. A flying head slider 21 is fixed to the surface of the gimbal spring. The gimbal spring allows the flying head slider 21 to change its attitude relative to the head suspension 19. A head element or electromagnetic transducer is mounted on the flying head slider 21, as described later in detail.

When the magnetic recording disk 13 rotates, the flying head slider 21 is allowed to receive an airflow generated along the rotating magnetic recording disk 13. The airflow serves to generate a positive pressure or a lift as well as a negative pressure on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the combination of the lift and the negative pressure.

When the carriage 15 swings around the vertical support shaft 17 during the flight of the flying head slider 21, the flying head slider 21 is allowed to move along the radial direction of the magnetic recording disk 13. The electromagnetic transducer on the flying head slider 21 is thus allowed to cross the data zone defined between the innermost and outermost recording tracks. The electromagnetic transducer on the flying head slider 21 is positioned right above a target recording track on the magnetic recording disk 13.

A power source such as a voice coil motor, VCM, 22 is coupled to the carriage block 16. The voice coil motor 22 serves to drive the carriage block 16 around the vertical support shaft 17. The rotation of the carriage block 16 allows the carriage arms 18 and the head suspensions 19 to swing.

A flexible printed wiring board 23 is supported on the carriage block 16. A head IC (integrated circuit) 24 is mounted on the flexible printed wiring board 23. The head IC 24 is designed to supply the read element of the electromagnetic transducer with a sensing current when the magnetic bit data is to be read. The head IC 24 is also designed to supply the write element of the electromagnetic transducer with a writing current when the magnetic bit data is to be written. A small-sized circuit board 25 is located within the inner space of the enclosure body 12. A printed wiring board, not shown, is attached to the back surface of the bottom plate of the enclosure body 12. The small-sized circuit board 25 and the printed wiring board are designed to supply the head IC 24 with the sensing current and the writing current.

A flexible printed wiring board 26 is utilized to supply the sensing current and writing current. The flexible printed wiring board 26 is related to the individual flying head slider 21. The flexible printed wiring board 26 includes a metallic thin film made of stainless steel or the like, an insulating layer, an electrically-conductive layer and a protection layer. The electrically-conductive layer includes a wiring pattern. The electrically-conductive layer may be made of an electrically-conductive material such as copper. The insulating layer and the protection layer may be made of a resin material such as polyimide resin.

The wiring pattern on the flexible printed wiring board 26 is connected to the flying head slider 21. The flexible printed wiring board 26 extends backward along the side of the carriage arm 18 from the head suspension 19. The rear end of the flexible printed wiring board 26 is connected to the flexible printed wiring board 23. The wiring pattern on the flexible printed wiring board 26 is connected to a wiring pattern on the flexible printed wiring board 23. Electrical connection is in this manner established between the flying head slider 21 and the flexible printed wiring board 23.

FIG. 2 illustrates a specific example of the flying head slider 21. The flying head slider 21 includes a slider body 31 in the form of a flat parallelepiped, for example. An insulating non-magnetic film, namely a head protection film 32, is overlaid on the outflow or trailing end surface of the slider body 31. The aforementioned electromagnetic transducer 33 is incorporated in the head protection film 32.

The slider body 31 may be made of a hard material such as Al₂O₃—Tic. The head protection film 32 is made of a soft material such as Al₂O₃ (alumina). A medium-opposed surface or bottom surface 34 is defined over the slider body 31 so as to face the magnetic recording disk 13 at a distance. A flat base surface 35 as a reference surface is defined on the bottom surface 34. When the magnetic recording disk 13 rotates, airflow 36 flows along the bottom surface 34 from the inflow or front end toward the outflow or rear end of the slider body 31.

A front rail 37 is formed on the bottom surface 34 of the slider body 31. The front rail 37 stands upright from the base surface 35 of the bottom surface 34 near the inflow end of the slider body 31. The front rail 37 is designed to extend along the inflow end of the base surface 35 in the lateral direction of the slider body 31. The front rail 37 has a predetermined thickness on the base surface 35.

A rear rail 38 is likewise formed on the bottom surface 34 of the slider body 31. The rear rail 38 stands upright from the base surface 35 of the bottom surface 34 near the outflow end of the slider body 31. The rear rail 38 is located at the intermediate position in the lateral direction of the slider body 31. The rear rail 38 is designed to extend toward the outflow end of the base surface 35. The rear rail 38 has a thickness equal to the thickness of the front rail 37 on the base surface 35.

A pair of auxiliary rear rails 39a, 39b is likewise formed on the bottom surface 34 of the slider body 31. The auxiliary rear rails 39a, 39b stand upright from the base surface 35 of the bottom surface 34 near the outflow end of the slider body 31. The auxiliary rear rails 39a, 39b are located near the sides of the base surface 35, respectively. The auxiliary rear rails 39a, 39b are thus distanced from each other in the lateral direction of the slider body 31. The rear rail 38 is located in a space between the auxiliary rear rails 39a, 39b.

A front air bearing surface 41 is defined on the top surface of the front rail 37. A step 42 is formed at the inflow end of the front air bearing surface 41. A low level surface 43 is thus defined on the top surface of the front rail 37 at a position upstream of the front air bearing surface 41. The low level surface 43 extends at a level lower than that of the front air bearing surface 41.

A rear air bearing surface 44 is likewise defined on the top surface of the rear rail 38. A step 46 is formed at the inflow end of the rear air bearing surface 44. A low level surface 47 is thus defined on the top surface of the rear rail 38 at a position upstream of the rear air bearing surface 44. The low level surface 47 extends at a level lower than that of the rear air bearing surface 44.

An auxiliary air bearing surface 48 is likewise defined on the top surface of each of the auxiliary rear rails 39a, 39b. The auxiliary air bearing surfaces 48 are respectively located along the sides of the base surface 35. The auxiliary air bearing surfaces 48 are thus spaced from each other in the lateral direction of the slider body 31. The rear air bearing surface 44 is located in a space between the auxiliary air bearing surfaces 48. A step 49 is formed at the inflow end of the individual auxiliary air bearing surface 48. A low level surface 51 is defined on the top surface of each of the auxiliary rear rails 39a, 39b at a position upstream of the auxiliary air bearing surface 48. The low level surface 51 extends at a level lower than that of the auxiliary air bearing surface 48.

The aforementioned electromagnetic transducer 33 is embedded in the rear rail 38. The electromagnetic transducer 33 includes a read element and a write element. The electromagnetic transducer 33 is designed to expose a read gap and a write gap at positions downstream of the rear air bearing surface 44.

A protection film, not shown, is formed on the surface of the slider body 31 at the front air bearing surface 41, the rear air bearing surface 44 and the auxiliary air bearing surfaces 48, for example. The protection film covers over the read gap and the write gap at the rear air bearing surface 44. The protection film may be made of diamond-like-carbon (DLC), for example.

The bottom surface 34 of the flying head slider 21 is designed to receive the airflow 36 generated along the rotating magnetic recording disk 13. The steps 42, 46, 49 serve to generate a larger positive pressure or lift at the air bearing surfaces 41, 44, 48, respectively. Moreover, a larger negative pressure is induced behind the front rail 37 or at a position downstream of the front rail 37. The negative pressure is balanced with the lift so as to stably establish the flying attitude of the flying head slider 21.

A larger positive pressure or lift is generated at the front air bearing surface 41 as compared with the air bearing surfaces 44, 48 in the flying head slider 21. When the slider body 31 flies above the surface of the magnetic recording disk 13, the slider body 31 can be kept at an inclined attitude defined by a pitch angle α. The term “pitch angle” is used to define an inclined angle in the longitudinal direction of the slider body 31 along the direction of the airflow 36.

A lift is equally generated in the pair of auxiliary air bearing surfaces 48, 48. This serves to suppress change in a roll angle β of the flying head slider 21 during the flight. The auxiliary air bearing surfaces 48, 48 are thus prevented from contact or collision against the magnetic recording disk 13. The term “roll angle” is used to define an inclined angle in the lateral direction of the slider body 31 perpendicular to the direction of the airflow 36.

A pair of side rails 52a, 52b are also formed on the bottom surface 34 of the slider body 31. The side rails 52a, 52b stand upright from the base surface 35 of the bottom surface 34 at positions downstream of the front rail 37. The side rails 52a, 52b end at positions spaced from the corresponding auxiliary rear rails 39a, 39b. The inflow ends of the side rails 52a, 52b are connected to the outflow end surface of the front rail 37 at the opposite ends of the front rail 37 in the lateral direction, respectively. Each of the side rails 52a, 52b defines the top surface extending at the level equal to that of the low level surfaces 43, 47. The top surfaces of the side rails 52a, 52b thus extend at a level lower than that of the front air bearing surface 41.

The side rails 52a, 52b serve to prevent airflow from running into a space behind the front rail 37 around the opposite ends of the front rail 37 in the lateral direction during the flight of the flying head slider 21. The airflow 36 is thus allowed to expand in a direction perpendicular to the base surface 34 at a position behind the front rail 37 when the airflow has passed through the front air bearing surface 41. This rapid expansion of the airflow contributes to generation of the negative pressure behind the front rail 37.

As shown in FIG. 3, the slider body 31 defines a first area 55 and second areas 56a, 56b. The first area 55 and the second areas 56a, 56b are designed to extend side by side on the bottom surface 34 from the inflow end to the outflow end. The boundaries between the first area 55 and the second areas 56a, 56b extend in parallel with the sides of the flying head slider 21 or the slider body 31. Here, the boundaries between the first area 55 and the second areas 56a, 56b are respectively aligned with the opposite ends of the electromagnetic transducer 33 in the lateral direction.

The head protection film 32 defines a first section 57 located within the first area 55 and a second section 58 located within the second area 56b, for example. The aforementioned electromagnetic transducer 33 is embedded within the first section 57. A first actuator is embedded within the head protection film 32 in the first area 55 so as to enable protrusion of the first section 57 as described later. A second actuator is embedded within the head protection film 32 in the second area 56b so as to enable protrusion of the second section 58. The first and second actuators are described later in detail.

FIG. 4 illustrates the bottom surface 34 of the flying head slider 21 in detail. The electromagnetic transducer 33 includes a write head 61 and a read head 62. As conventionally known, the write head 61 utilizes a magnetic field generated at a magnetic coil for writing binary data into the magnetic recording disk 13, for example. A magnetoresistive (MR) element such as a giant magnetoresistive (GMR) element, a tunnel-junction magnetoresistive (TMR) element, or the like, may be employed as the read head 62. The read head 62 is usually designed to detect binary data based on variation in the electric resistance in response to the inversion of polarization in the magnetic field applied from the magnetic recording disk 13.

The read head 62 includes a magnetoresistive film 63, such as a spin valve film, a tunnel junction film, or the like. The magnetoresistive film 63 is interposed between a pair of electrically-conductive layers or upper and lower shielding layers 64, 65. The upper shielding layer 64 extends along a plane parallel to the lower shielding layer 65. The upper and lower shielding layers 64, 65 may be made of a magnetic material such as FeN, NiFe, or the like.

The magnetoresistive film 63 is embedded within an insulating layer 66 covering over the upper surface of the lower shielding layer 65. The insulating layer 66 is made of Al₂O₃, for example. The upper shielding layer 64 extends along the upper surface of the insulating layer 66. The magnetoresistive film 63 is electrically connected separately to the lower and upper shielding layers 65, 64. A gap between the upper and lower shielding layers 64, 65 determines a linear resolution of magnetic recordation on the magnetic recording disk 13 along the recording track.

The write head 61 includes upper and lower magnetic pole layers 67, 68. The front ends of the upper and lower magnetic pole layers 67, 68 are exposed at the rear air bearing surface 44. The lower magnetic pole layer 68 extends along a plane parallel to the upper shielding layer 64. A front end magnetic pole 69 is formed on the lower magnetic pole layer 68. The front end of the front end magnetic pole 69 is exposed at the rear air bearing surface 44. The upper and lower magnetic pole layers 67, 68 and the front end magnetic pole 69 may be made of FeN, NiFe, or the like. The upper and lower magnetic pole layers 67, 68 and the front end magnetic pole 69 in combination serve as a magnetic core of the write head 61.

The front end magnetic pole 69 is opposed to the upper magnetic pole layer 6. A non-magnetic gap layer 71 made of Al₂O₃ or the like is interposed between the upper magnetic pole layer 67 and the front end magnetic pole 69. As conventionally known, when a magnetic field is generated in the aftermentioned magnetic coil, the non-magnetic gap layer 71 serves to leak a magnetic flux between the upper and lower magnetic pole layers 67, 68 out of the bottom surface 34. The leaked magnetic flux forms a magnetic field for recordation. Specifically, a write gap is defined between the upper magnetic pole layer 67 and the front end magnetic pole 69. The write gap is located in the first section 57. The boundaries between the first area 55 and the second areas 56a, 56b may be aligned with the outer ends of the upper and lower shielding layers 64, 65 and the lower magnetic pole layer 68, for example.

Referring also to FIG. 5, the lower magnetic pole layer 68 is formed on an insulating layer 72 overlaid on the upper shielding layer 64 by a constant thickness. The insulating layer 72 serves to magnetically isolate the lower magnetic pole layer 68 from the upper shielding layer 64. The magnetic coil, namely a thin film coil 73, is formed on the lower magnetic pole layer 68. The thin film coil 73 is embedded within an insulating layer 72. The thin film coil 73 may be made of Cu, for example. The aforementioned upper magnetic pole layer 67 is formed on the upper surface of the non-magnetic gap layer 71. The rear end of the upper magnetic pole layer 67 is magnetically connected to that of the lower magnetic pole layer 68 at the center of the thin film coil 73. The upper and lower magnetic pole layers 67, 68 in combination serve as a magnetic core extending through the center of the thin film coil 73.

A heating wiring pattern 74 is embedded within the write head 61. The heating wiring pattern 74 may be made of tungsten, for example. Electric current is supplied to the heating wiring pattern 74. The wiring pattern of the flexible printed wiring board 26 is utilized for supply of electric current. The heating wiring pattern 74 gets heated in response to the supply of electric current. This results in expansion of the first section 57 of the head protection film 32 at a position adjacent to the heating wiring pattern 74. The first section 57, namely the electromagnetic transducer 33 is forced to protrude. The heating wiring pattern 74 and the first section 57 in combination serve as the aforementioned first actuator.

As shown in FIG. 6, the heating wiring pattern 74 is embedded within the first section 57 of the head protection film 32. A heating wiring pattern 75 is also embedded within the second section 58 of the head protection film 32. The heating wiring pattern 75 maybe made of tungsten, for example. Electric current is supplied to the heating wiring pattern 75. The wiring pattern of the flexible printed wiring board 26 is utilized for the supply of electric current. The heating wiring pattern 75 gets heated in response to the supply of electric current. This results in expansion of the second section 58 at a position adjacent to the heating wiring pattern 75. The second section 58 is in this manner forced to protrude. The heating wiring pattern 75 and the second section 58 in combination serve as the aforementioned second actuator. In this case, the heating wiring patterns 74, 75 may equally be distanced from the outflow end of the head protection film 32, for example.

A description will be made on a method of determining the protrusion amount of the electromagnetic transducer 33. As shown in FIG. 7, a determination apparatus 81 is utilized for determination of the protrusion amount. The determination apparatus 81 is connected to the hard disk drive 11. The determination apparatus 81 includes a controller circuit 82. The controller circuit 82 is designed to execute predetermined processing based on a software program 84 stored in a memory 83, for example. A recording medium such as a compact disk (CD), a flexible disk (FD) or the like may be utilized to bring the program 84 into the memory 83.

The controller circuit 82 includes a controlling section 85, a detection section 86 and a determination section 87. The determination apparatus 81 also includes an oscilloscope 88. The oscilloscope 88 is designed to detect the waveform of a binary data signal output from the read head 62. The controlling section 85 is designed to control the operation of the hard disk drive 11. The controlling section 85 serves to cause a protrusion of the second section 58, for example. The detection section 86 is designed to detect change in the wave form in the oscilloscope 88. The determination section 87 is designed to determine the protrusion amount of the electromagnetic transducer 33 depending on the change in the waveform in the oscilloscope 88 as described later in detail.

A predetermined binary data is first written into the magnetic recording disk 13 for determination of the protrusion amount. The controlling section 85 operates to supply electric current only to the heating wiring pattern 75. The heating wiring pattern 75 generates heat to cause a protrusion of the second section 58 toward the magnetic recording disk 13. Since no electric current is supplied to the heating wiring pattern 74, the first section 57 of head protection film 32 and the electromagnetic transducer 33 are prevented from protruding. The second section 58 protrudes by a larger amount in response to increase in the amount of electric current supplied to the heating wiring pattern 75. A proportional relationship is established between the protrusion amount of the second section 58 and the amount of electric current supplied to the heating wiring pattern 75.

Simultaneously, the sensing current is supplied to the read head 62 in response to instructions from the controlling section 85. The read head 62 detects the binary data in the magnetic recording disk 13. As shown in FIG. 8, the waveform of the binary data signal is observed in the oscilloscope 88. An increase in the protrusion amount of the second section 58 finally causes contact between the second section 58 and the magnetic recording disk 13. The contact causes a vibration of the flying head slider 21. This results in noise in the waveform of the binary data signal. The detection section 86 detects the noise in the waveform. The detection of the noise in the waveform represents a contact between the second section 58 and the magnetic recording disk 13. A so-called zero calibration is executed.

The determination section relates the protrusion amount of the second section 58 during the contact to the flying height “zero” of the electromagnetic transducer 33. Since the protrusion amount of the second section 58 coincides with that of the first section 57, the determination section 87 determines the protrusion amount of the first section 57 based on the target flying height of the electromagnetic transducer 33. The zero calibration is executed for each of the flying head sliders 21. The protrusion amount of the first section 57 is determined for each of the flying head sliders 21 in this manner. The amount of electric current to the heating wiring pattern 74 depends on the protrusion amount set for each of the flying head sliders 21. The amount of electric current to the heating wiring pattern 74 may be written into a memory in the hard disk drive 11, for example.

The hard disk drive 11 is then incorporated in a product. When the hard disk drive 11 is in operation, a controller of the hard disk drive 11 takes the amounts of electric current from the memory. The controller adjusts the amount of electric current to the heating wiring pattern 74 in view of the target flying height of the flying head slider 21. The protrusion amount of the first section 57 is adjusted for each of the flying head sliders 21 in this manner. Each of the flying head sliders 21 is thus controlled to enjoy the flight at the target flying height. After the hard disk drive 11 has completely been installed in the product, only the heating wiring pattern 74 is supplied with electric current in the hard disk drive 11. Specifically, the heating wiring pattern 75 is utilized only for the zero calibration.

The flying head slider 21 is allowed to determine the flying height based on the protrusion amount of the second section 58 during the contact. The second section 58 is brought in contact with the magnetic recording disk 13 for the determination. Since the second section 58 fails to contain the electromagnetic transducer 33, the electromagnetic transducer 33 is surely prevented from protrusion. The first section 57 is not utilized in the zero calibration. The protrusion amount or flying height of the electromagnetic transducer 33 can be determined without any damage to the electromagnetic transducer 33. This results in avoidance of variation in the flying height.

Since the electromagnetic transducer 33 is prevented from contacting the magnetic recording disk 13, the electromagnetic transducer 33 fails to suffer form abrasion of the protection film covering over the electromagnetic transducer 33. The protection film is expected to keep protecting the electromagnetic transducer 33 from corrosion for a longer period of time. Moreover, the heating wiring patterns 74, 75 are equally distanced from the outflow end of the head protection film 32. The protrusion amount of the second section 58 always reflects the protrusion amount of the first section 57 irrespective of a change in the pitch angle a of the flying head slider 21. The flying height of the electromagnetic transducer 33 can be determined with accuracy.

As shown in FIG. 10, the width of the first area 55 may be set equal to the core width of the write gap defined between the upper magnetic pole layer 67 and the front end magnetic pole 69. In this case, the write gap of the write head 61 and the magnetoresistive film 63 of the read head 62 are located in the first area 55. Here, the first and second sections 57, 58 are overlapped on each other. The heating wiring pattern 75 is embedded within the write head 61, for example. Like reference numerals are attached to the structure or components equivalent to those of the aforementioned embodiment.

FIG. 11 schematically illustrates the protrusion of the first and second sections 57, 58. Here, the width L1 of the lower shielding layer 65 may be set at 60 μm approximately, for example. The upper magnetic pole layer 67 is positioned at the peak of protrusion of the first section 57 in response to the supply of electric current to the heating wiring pattern 74. The upper magnetic pole layer 67 is positioned off the peak of protrusion of the second section 58 in response to the supply of electric current to the heating wiring pattern 75. The second section 58 is thus allowed to contact with the magnetic recording disk 13 at a position distanced from the upper magnetic pole layer 67.

The inventor has observed that the peak of protrusion of the first section 57 lies in a range of 20 μm approximately away from the center of the upper magnetic pole layer 67 in response to the supply of electric current to the heating wiring pattern 74. An atomic force microscope (AFM) was utilized to locate the peak of protrusion. The peak of protrusion of the second section 58 is likewise expected to lie in a range of 20 μm approximately from the center of the upper magnetic pole layer 67. As long as the peak of protrusion of the second section 58 is distanced from the center of the upper magnetic pole layer 67 at a distance L2 larger than 20 μm, the upper magnetic pole layer 67 can be placed off the peak of protrusion of the second section 58 during the protrusion of the second section 58. Accordingly, the write gap and/or read gap can thus be protected from damages even if the second section 58 is brought in contact with the magnetic recording disk 13 at the peak of protrusion.

Otherwise, the heating wiring pattern 74 may be distanced from the outflow end of the head protection film 32 by an amount different from the distance between the heating wiring pattern 75 and the outflow end of the head protection film 32. The heating wiring pattern 75 may be shifted away from the outflow end of the head protection film 32 by an amount significantly larger than the distance between the heating wiring pattern 74 and the outflow end, for example. In this case, as long as a relationship is figured out between the protrusion amount of the second section 58 and that of the first section 57, the flying height of the electromagnetic transducer 33 can be determined based on the protrusion amount of the second section 58 without any damage to the electromagnetic transducer 33 in the same manner as described above.

What is claimed is:

1. A head slider comprising:
a slider body having a medium-opposed surface opposed to a storage medium, the medium-opposed surface defining first and second areas extending side by side from an inflow end to an outflow end;
an insulating non-magnetic film overlaid on an outflow end surface of the slider body;
a head element embedded in the insulating non-magnetic film, said head element at least locating a write gap in a first section defined in the insulating non-magnetic film in the first area;
a first actuator embedded in the insulating non-magnetic film in the first area, said actuator causing the first section of the insulating non-magnetic film to protrude; and
a second actuator embedded in the insulating non-magnetic film in the second area, said second actuator causing a second section of the insulating non-magnetic film to protrude.

2. The head slider according to claim 1, wherein the first actuator includes a heating wiring pattern embedded in the first section of the insulating non-magnetic film.

3. The head slider according to claim 1, wherein the second actuator includes a heating wiring pattern embedded in the second section of the insulating non-magnetic film.

4. A storage medium drive comprising:
a head slider having a medium-opposed surface opposed to a storage medium, the medium-opposed surface defining first and second areas extending side by side from an inflow end to an outflow end;
an insulating non-magnetic film overlaid on an outflow end surface of the head slider;
a head element embedded in the insulating non-magnetic film, said head element at least locating a write gap in a first section defined in the insulating non-magnetic film in the first area;
a first actuator embedded in the insulating non-magnetic film in the first area, said first actuator causing the first section of the insulating non-magnetic film to protrude; and
a second actuator embedded in the insulating non-magnetic film in the second area, said second actuator causing a second section of the insulating non-magnetic film to protrude.

5. A determination apparatus for determining protrusion amount of a head element, comprising:
a controlling section designed to cause a non-magnetic film of a head slider to protrude without causing a protrusion of a head element embedded in the non-magnetic film;
a detection section designed to detect contact between the non-magnetic film and a storage medium in response to increase in a protrusion amount of the non-magnetic film; and
a determination section designed to determine a protrusion amount of the head element based on a protrusion amount of the non-magnetic film during the contact.

6. The determination apparatus according to claim 5, wherein the head slider comprises:
a slider body having a medium-opposed surface opposed to the storage medium, the medium-opposed surface defining first and second areas extending side by side from an inflow end to an outflow end;
the non-magnetic film having insulation and overlaid on an outflow end surface of the slider body;
a head element embedded in the non-magnetic film, said head element at least locating a write gap in a first section defined in the non-magnetic film in the first area;
a first actuator embedded in the non-magnetic film in the first area, said first actuator causing the first section of the non-magnetic film to protrude; and
a second actuator embedded in the non-magnetic film in the second area, said second actuator causing a second section of the non-magnetic film to protrude.

7. The determination apparatus according to claim 6, wherein the first actuator includes a heating wiring pattern embedded in the first section of the non-magnetic film.

8. The determination apparatus according to claim 6, wherein the second actuator includes a heating wiring pattern embedded in the second section of the non-magnetic film.
